(19) United States
(12) Patent Application Publication
(10) Pub. No.: US 2025/0045483 A1
(43) Pub. Date: Feb. 6, 2025

(54) INFORMATION PROCESSING APPARATUS AND SIMULATION METHOD

(71) Applicant: Panasonic Intellectual Property Management Co., Ltd., Osaka (JP)

(72) Inventors: Akihiro EGAMI, Tokyo (JP); Takenori SAKAMOTO, Kanagawa (JP); Hiroshi TAKAHASHI, Kanagawa (JP); Naganori SHIRAKATA, Osaka (JP); Koji TAKINAMI, Kanagawa (JP)

(21) Appl. No.: 18/719,718

(22) PCT Filed: Jun. 10, 2022
(86) PCT No.: PCT/JP2022/023517

§ 371 Date: Jun. 13, 2024

(30) Foreign Application Priority Data
Dec. 22, 2021 (JP) 2021-208509

(51) Int. Cl. G06F 30/20; G06F 111/02

(52) U.S. Cl. CPC G06F 30/20; G06F 2111/02

(57) ABSTRACT

This information processing apparatus comprises a simulation circuit that sets the operation of a device included in a network, and that simulates the operation of the network; and a display circuit that displays the result of the simulation and setting information indicating setting contents of the device on a display apparatus.

### TECHNICAL FIELD

The present disclosure relates to an information processing apparatus and a simulation method.

### BACKGROUND ART

In recent years, the scale of an industrial network that includes an industrial device such as a production line in a factory increases and becomes complicated. For this reason, in the case where a user purchases a new device and adds the new device into the industrial network, or in the case where the user replaces an existing device with the new device in order to improve productivity, it is difficult to select an appropriate new device.

In PTL 1, a recommendation system that recommends a preferable network device is proposed. The recommendation system in PTL 1 runs a simulation regarding the performance of a network and a device in the case where the device that is not purchased by a user is introduced into the network. The recommendation system in PTL 1 provides recommendation information to the user, based on the result of the simulation.

In some cases where a new device is introduced into an industrial network, and the target performance of the industrial network is achieved, the operation of a device that is included in the industrial network is appropriately set in addition to the selection of the new device.

### CITATION LIST

### Patent Literature

PTL 1

WO 2018/181826

### SUMMARY OF INVENTION

However, the recommendation system in PTL 1 recommends a device that is included in a network that is simulated but does not provide setting information for setting the operation of the recommended device.

For this reason, as for the recommendation system in PTL 1, in the case where the user uses the recommended device and establishes the network, the user oneself needs to set the operation of the recommended device, which needs time and effort.

A nonrestrictive example of the present disclosure is useful to provide an information processing apparatus and a simulation method that enable setting information about a device that is included in a network the operation of which is simulated to be provided and enable a user to easily establish the network the operation of which is simulated.

An information processing apparatus according to one example of the present disclosure includes: a simulation circuit that sets an operation of a device included in a network and that runs a simulation of an operation of the network; and a display circuit that causes a display device to display a result of the simulation and setting information that represents a setting content of the device.

A simulation method according to one example of the present disclosure includes: setting an operation of a device included in a network and running a simulation of an operation of the network; and causing a display device to display a result of the simulation and setting information that represents a setting content of the device.

It should be noted that general or specific embodiments may be implemented as a system, an apparatus, a method, an integrated circuit, a computer program, or a storage medium, or any selective combination of a system, an apparatus, a method, an integrated circuit, a computer program, and a storage medium.

In an example of the present disclosure, a user can easily establish a network the operation of which is simulated.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF DRAWINGS

FIG. 1 illustrates an example of the structure of an information processing apparatus according to Embodiment of the present disclosure;

FIG. 2 illustrates an example of an input screen that receives network information;

FIG. 3 illustrates an example of a device candidate table for a new device;

FIG. 4 illustrates an example of an actual measurement model table;

FIG. 5A illustrates an example of a function of a packet transmission capability model in device information “plc_000” in FIG. 4;

FIG. 5B illustrates an example of a function of a processing delay model in the device information “plc_000” in FIG. 4;

FIG. 6 illustrates an example of an output screen that is displayed on a display; and

FIG. 7 is a flowchart illustrating an example of the operation of the information processing apparatus.

### DESCRIPTION OF EMBODIMENTS

Embodiments of the present invention will be described below in detail with reference to the accompanying drawings as appropriate. It is, however, noted that a description made in detail more than necessary is omitted in some cases. For example, a detailed description of an already well-known item and a duplicate description of substantially the same configuration are omitted in some cases. The reason for this is to prevent the following description from being unnecessarily redundant and allow a person skilled in the art to readily understand the present disclosure.

The accompanying drawings and the following descriptions are provided to allow a person skilled in the art to fully understand the present disclosure and are not intended to limit the subject set forth in the appended claims.

In some cases where a new device is introduced into an industrial network, and the performance of the industrial network is improved, device settings of a device that is included in the industrial network are adjusted in addition to the selection of the new device. For example, the device settings such as a timing with which control traffic is generated, and priority control regarding a queue of a switch are adjusted for industrial devices that are included in the industrial network such as a PLC (Programmable Logic Controller), a sensor, and an actuator.

In some cases where the new device is introduced into the industrial network, a network topology is changed, and the device settings of the device that is included in the industrial network are not updated, the performance of the network does not reach target performance. In a case that is presumed by way of example, the existing device is replaced with the new device that has higher processing performance, and the production cycle time of a product is improved. In some of such cases, the production cycle time of the product is not improved, for example, if a timing with which the traffic of the device (this may include the existing device) that is included in the industrial network is generated is not changed as the processing time of the new device reduces.

Accordingly, the new device is selected from a new device candidate group and is disposed in the industrial network of a user, and the operation of the industrial network is simulated. In addition to this, the device settings of the devices are changed into various settings, and the simulation is run in some cases. The result of selection of the new device and setting information that represents a setting content of the device that is included in the industrial network that is simulated are combined and provided to the user based on the result of the simulation of the industrial network, and consequently, the performance of the industrial network can be improved.

The industrial network is simply referred to below as the network in some cases. The industrial device is simply referred to as the device in some cases. The industrial network may be referred to as an industrial system or a system.

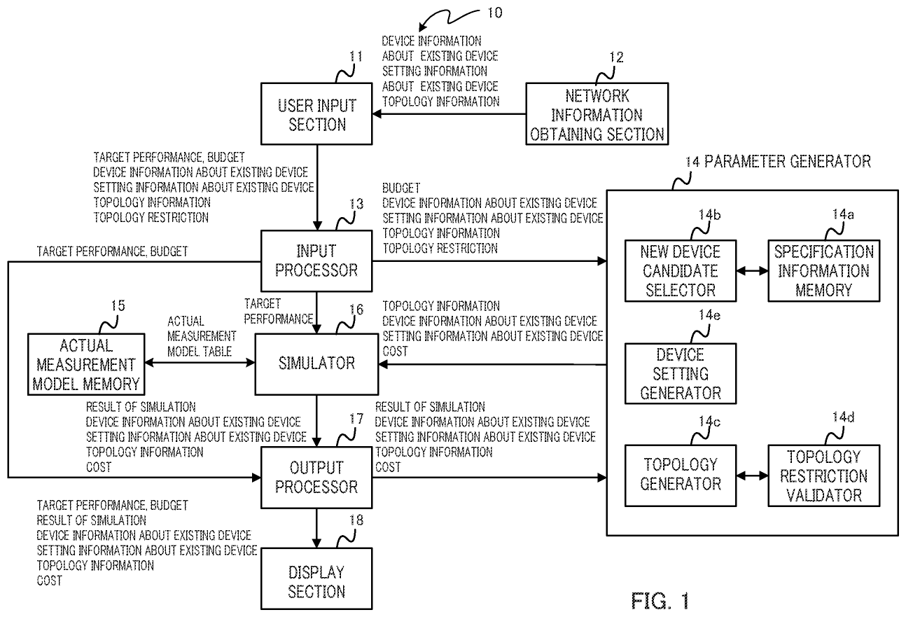

FIG. 1 illustrates an example of a block structure of information processing apparatus 10 according to Embodiment of the present disclosure. Examples of information processing apparatus 10 illustrated in FIG. 1 may be an apparatus such as a personal computer or a server.

For example, information processing apparatus 10 may include a processor such as a CPU (Central Processing Unit) and a memory. As for information processing apparatus 10, the processor may fulfil the functions of components illustrated in FIG. 1 by running a program that is stored in the memory. Specification information memory 14a and actual measurement model memory 15 may be included in the memory of information processing apparatus 10. The processor may be referred to as a controller.

As illustrated in FIG. 1, information processing apparatus 10 includes user input section 11, network information obtaining section 12, input processor 13, parameter generator 14, actual measurement model memory 15, simulator 16, output processor 17, and display section 18.

### User Input Section

User input section 11 receives network information about the structure and settings of the network from an input device (not illustrated) such as a keyboard, a mouse, or a touch screen. User input section 11 outputs the network information that is received from the input device to input processor 13.

For example, the network information includes information such as the topology restriction, budget, and the target performance of a network that is to be newly established by the user. For example, the network information also includes information such as device information about the existing device of the network (the existing network) that is currently established by the user, setting information about the existing device, and topology information.

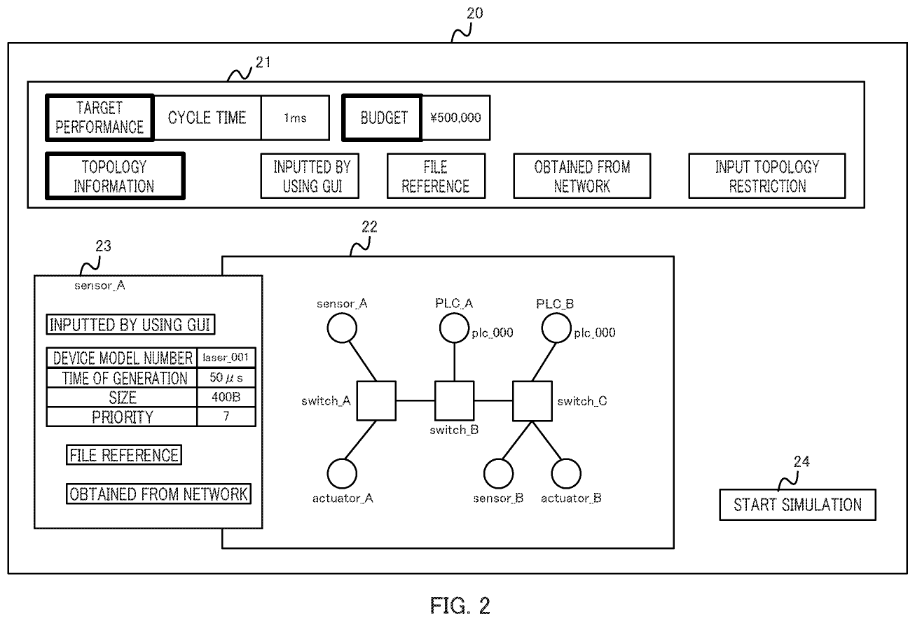

FIG. 2 illustrates an example of input screen 20 that receives the network information. Input screen 20 illustrated in FIG. 2 is displayed on a display (not illustrated in FIG. 1) of information processing apparatus 10. As illustrated in FIG. 2, input screen 20 may be a GUI (Graphical User Interface). User input section 11 may input the network information via the GUI of input screen 20.

As illustrated in FIG. 2, input screen 20 includes setting input image section 21, network structure display image section 22, device-related information input image section 23, and button image section 24 that starts the simulation. The image sections of input screen 20 will now be described.

### Setting Input Image Section

Setting input image section 21 includes an image section that inputs an item of the target performance of the network. An example of the image section that inputs the item of the target performance of the network may be a pull-down list. The item of the target performance of the network may be selected from multiple items of the pull-down list. Examples of the item of the target performance of the network include the production cycle time of a product, a packet delay between specific devices, and the number of transmitted packets. FIG. 2 illustrates an example in which the “cycle time” is selected.

Setting input image section 21 includes an image section that inputs the target performance regarding the item of the target performance of the network. An example of the image section that inputs the target performance may be a pull-down list. FIG. 2 illustrates an example in which “1 ms” is selected (set) regarding the item “cycle time” of the target performance of the network.

Setting input image section 21 includes an input section that inputs a budget that can be used for improving the network (the new network). An example of the input section that inputs the budget may be a text box, and a numeral may be inputted. FIG. 2 illustrates an example in which “¥500,000” is inputted.

Setting input image section 21 includes an image section (for example, a button image) that selects a method of inputting the topology information that represents the topology of the network that is currently established by the user. For example, setting input image section 21 includes an image section that selects a method of inputting the topology information that represents relationships in connection between the existing network and the devices.

Multiple methods of inputting the topology information may be provided. Examples thereof include a method of inputting the topology information by using a GUI, a method of inputting the topology information by referring a file, and a method of obtaining the topology information from the network.

For example, a button image on which “INPUTTED BY USING GUI” is displayed as illustrated in FIG. 2 is pushed (or clicked), and the topology information is subsequently inputted via the GUI that is displayed on the display. For example, a button image on which “FILE REFERENCE” is displayed as illustrated in FIG. 2 is pushed, and the topology information is subsequently inputted from a file in which the topology information is saved. The file may be stored in the memory of information processing apparatus 10 or may be stored in an external memory such as a USB memory. For example, a button image on which “OBTAINED FROM NETWORK” is displayed as illustrated in FIG. 2 is pushed, and the topology information is subsequently obtained from the network (for example, a device that is included in a production line network) that is connected to information processing apparatus 10.

Setting input image section 21 includes an image section that inputs the topology restriction of the new network. The topology restriction corresponds to information that represents that it is difficult to connect specific devices to each other, for example, it is difficult to physically connect a wire between the devices. For example, a button image on which “INPUT TOPOLOGY RESTRICTION” is displayed as illustrated in FIG. 2 is pushed, and a text box for inputting the topology restriction is subsequently displayed.

For example, the user inputs the target performance to be obtained regarding the new network into setting input image section 21. The user inputs the budget that can be used for establishing the new network into setting input image section 21. The user inputs, as the topology information, the topology information about the network (the existing network before improvement) that is currently established into setting input image section 21. The user inputs, as the topology restriction, a restriction on the topology regarding the new network into setting input image section 21.

### Network Structure Display Image Section

The topology information is inputted into setting input image section 21, and the topology of the network based on the inputted topology information is subsequently displayed on network structure display image section 22. For example, the topology of the network that includes devices such as a sensor, a PLC, and a switch is displayed on network structure display image section 22 in FIG. 2.

The topology information about the network that is currently established by the user is inputted into setting input image section 21 as described above. Accordingly, the topology of the network that is currently established by the user is displayed on network structure display image section 22 in FIG. 2.

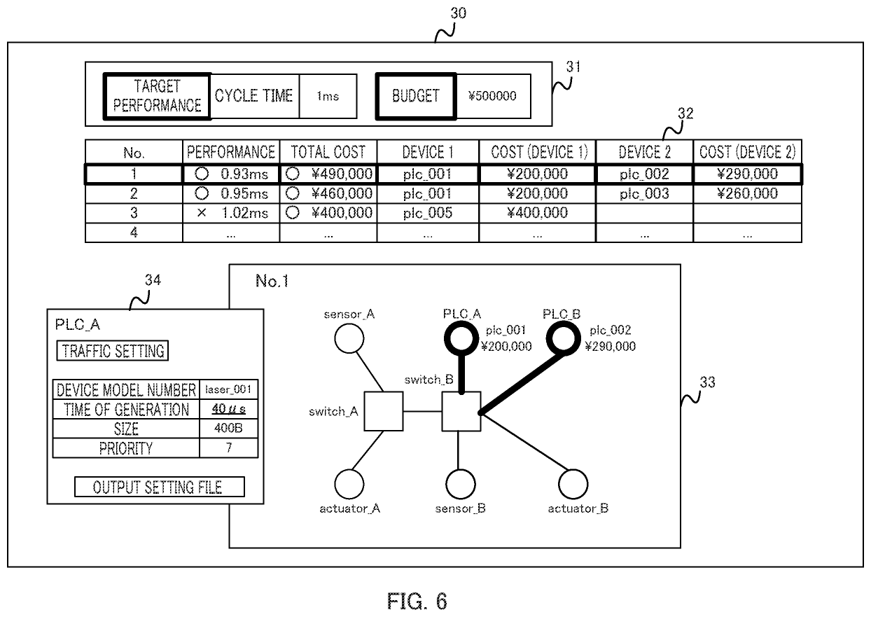

Button image section 24 illustrated in FIG. 2 is pushed, and the topology of the new network that satisfies the target performance, the budget, and the topology restriction that are inputted into setting input image section 21 is subsequently displayed on the display of information processing apparatus 10 (for example, recommendation network image section 33 in FIG. 6 is referred).

### Device-Related Information Input Image Section

Device-related information input image section 23 includes an input section that inputs the device information about the existing device that is included in the existing network and the setting information about the existing device.

An example of the device information is information for identifying the device such as the model number and name of the device.

An example of the setting information is information for setting the operation of the device. The setting information changes depending on the device, and examples thereof in the case where the device is a PLC, a sensor, or an actuator include information such as a timing with which traffic is generated, a data size, and priority settings. In the case of a switch, the setting information is information about settings of an algorithm for queue priority control or a gate that controls the outputs a queue. An example of the algorithm for queue priority control is a strict priority algorithm. As for strict priority, a packet is transmitted from a high-priority queue, but a packet is not transmitted from a low-priority queue until the transmission of the packet of the high-priority queue ends.

Device-related information input image section 23 may be displayed, for example, in the case where the existing device of the existing network that is displayed on network structure display image section 22 is selected. In an example illustrated in FIG. 2, “sensor_A” in the topology that is displayed on network structure display image section 22 is clicked (selected), and device-related information input image section 23 for “sensor_A” is displayed in a dialog box.

Device-related information input image section 23 may include an image section (for example, a button image) that selects a method of inputting the device information and the setting information. Multiple methods of inputting the device information and the setting information may be provided, and examples thereof may include a method of inputting the information by using a GUI, a method of inputting the information by referring a file, and a method of obtaining the information from the network.

For example, a button on which “INPUTTED BY USING GUI” is displayed as illustrated in FIG. 2 is pushed, and the setting information and the device information about “sensor_A” are subsequently inputted via a GUI. For example, a button on which “FILE REFERENCE” is displayed as illustrated in FIG. 2 is pushed, and the setting information and the device information about “sensor_A” are subsequently inputted from a file in which the device information and the setting information are saved. The file may be stored in the memory of information processing apparatus 10 or may be stored in an external memory. For example, a button on which “OBTAINED FROM NETWORK” is displayed as illustrated in FIG. 2 is pushed, and the setting information and the device information about “sensor_A” are obtained from the network (the device that is included in the production line network) that is connected to information processing apparatus 10.

The image sections of input screen 20 are described above.

### Network Information Obtaining Section

Network information obtaining section 12 obtains the device information, the setting information, and the topology information from each device that is connected to the current network and that is included in the current network.

For example, in the case where the button on which “OBTAINED FROM NETWORK” is displayed that is displayed on setting input image section 21 in FIG. 2 is pushed, network information obtaining section 12 obtains information that represents the relationships in connection from the devices that are included in the current network and obtains the topology information. For example, in the case where the button on which “OBTAINED FROM NETWORK” is displayed that is displayed on device-related information input image section 23 in FIG. 2 is pushed, network information obtaining section 12 obtains the device information and the setting information from the devices that are included in the current network.

### Input Processor

Input processor 13 outputs the budget, the device information about the existing device, the setting information about the existing device, the topology information, and the topology restriction that are outputted from user input section 11 to parameter generator 14. Input processor 13 outputs the target performance that is outputted from user input section 11 to simulator 16. Input processor 13 outputs the budget and the target performance of the network that are outputted from user input section 11 to output processor 17.

### Parameter Generator

Parameter generator 14 generates parameters that are used for the simulation of simulator 16. Parameter generator 14 outputs the generated parameters to simulator 16. Examples of the parameters include the topology information that represents the new network, the setting information and the device information about the existing device and the new device that are included in the new network, and costs.

Parameter generator 14 includes specification information memory 14a, new device candidate selector 14b, topology generator 14c, topology restriction validator 14d, and device setting generator 14e. Components of parameter generator 14 will now be described.

### Specification Information Memory

Specification information about various devices is registered in specification information memory 14a. Specification information memory 14a may store specification information about the existing device. Examples of the specification information include the device information and information about the specifications of the devices such as the kinds of the device settings, a range that can be set for every kind of the device settings, and the costs of the devices.

For example, in the case where the devices are PLCs, sensors, or actuators, the kinds of the device settings include the timing with which the traffic is generated, the data size, and the priority settings. For example, in the case where the devices are switches, the kinds of the device settings include the algorithm for queue priority control and the gate that controls the output of the queue.

The specification information about the devices may be stored in an external memory device. For example, the specification information may be stored in a server that is connected to a network such as the internet.

### New Device Candidate Selector

New device candidate selector 14b generates a device candidate table for the new device, based on the device information about the existing device and the budget that are outputted from input processor 13 and the costs of the devices that are stored in the specification information memory 14a.

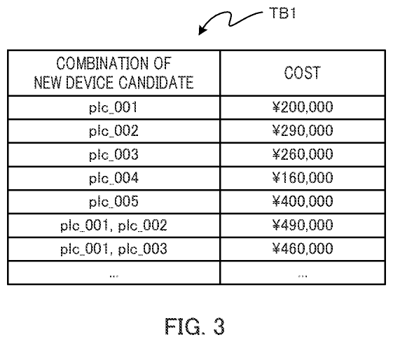

FIG. 3 illustrates an example of device candidate table TB1 for the new device. Device candidate table TB1 illustrated in FIG. 3 is an example of a table in the case where the budget is five hundred thousand yen. Device candidate table TB1 is stored in the memory of information processing apparatus 10.

New device candidate selector 14b refers specification information memory 14a and obtains the device information about the new device that satisfies the budget (five hundred thousand yen) and the cost thereof. New device candidate selector 14b associates the obtained device information about the new device and the cost with each other and generates device candidate table TB1.

New device candidate selector 14b can determine the device information about the new device, based on the device information about the existing device that is outputted from input processor 13. For example, new device candidate selector 14b may determine that device information other than the device information about the existing device that is outputted from input processor 13 is the device information about the new device. New device candidate selector 14b may refer specification information memory 14a, based on the determined device information about the new device and may obtain the device information about the new device that satisfies the budget and the cost thereof.

As illustrated in FIG. 3, device candidate table TB1 stores information that represents correspondence between the device information about the new device that can be purchased within the budget and the cost of the new device. The new device that can be purchased within the budget may be a combination of multiple devices. As illustrated in FIG. 3, examples thereof may include a combination of “plc_001” and “plc_002” and a combination of “plc_001” and “plc_003”. New device candidate selector 14b generates device candidate table TB1 such that the cost of each device of the new device and the total cost of the costs of the respective devices of the new device are within the budget (within five hundred thousand yen).

It can be understood that device candidate table TB1 stores candidates of the new device that can be included in the new network.

### Topology Generator

Topology generator 14c refers device candidate table TB1 illustrated in FIG. 3 and changes the topology information (changes the existing network) that is outputted from input processor 13. Topology generator 14c outputs the changed topology information to simulator 16. It can be understood that the network that is represented by using the changed topology information is the new network.

Examples of a method of changing the topology information include replacing the existing device with the new device that is stored in device candidate table TB1 and adding the new device that is stored in device candidate table TB1 into the existing network. The examples of the method of changing the topology information also include changing the destination of connection of the existing device and changing the destination of connection of the new device. Examples of the case where the destinations of connection of the existing device and the new device are changed include the case where the existing connection is broken, and a device is connected to another device, the case where the number of devices to which a device is connected is increased, and the case where the number of devices to which a device is connected is reduced.

### Topology Restriction Validator

Topology restriction validator 14d verifies whether the topology information that is generated (changed) by topology generator 14c satisfies the topology restriction. In the case where the topology information that is generated by topology generator 14c does not satisfies the topology restriction, topology restriction validator 14d instructs topology generator 14c to generate the topology information again. Topology generator 14c generates another topology information, based on the instruction from topology restriction validator 14d.

### Device Setting Generator

Device setting generator 14e obtains the setting information about the existing device and the new device that are included in the network that is represented by the topology information that is generated by topology generator 14c. Device setting generator 14e outputs the obtained setting information about the existing device and the new device, the device information about the existing device and the new device, and the cost of the new device to simulator 16. The setting information about the existing device is obtained (outputted) from input processor 13. The cost and the setting information about the new device are obtained by referring specification information memory 14a.

Simulator 16 repeatedly runs the simulation in accordance with predetermined conditions, which will be described later. Device setting generator 14e changes the setting information about the existing device and the new device whenever the simulation is repeated.

In the case where the existing device and the new device are devices such as PLCs, sensors, or actuators, examples of the setting information to be changed include the timing with which the traffic is generated, the data size, and the priority. In the case where the existing device and the new device are devices such as PLCs, sensors, or actuators, for example, device setting generator 14e changes the timing with which the traffic is generated, the data size, and the priority and outputs these to simulator 16.

In the case the existing device and the new device are devices such as switches, the setting information to be changed includes the algorithm for queue priority control and opening and closing the gate that controls the output of the queue. In the case where the existing device and the new device are devices such as switches, for example, device setting generator 14e changes the algorithm for queue priority control and opening and closing the gate that controls the output of the queue and outputs these to simulator 16.

The components of parameter generator 14 are described above.

### Actual Measurement Model Memory

Actual measurement model memory 15 includes an actual measurement model table in which the device information about each device and an actual measurement model are associated with each other. The actual measurement model table is used for the simulation of simulator 16, which will be described later.

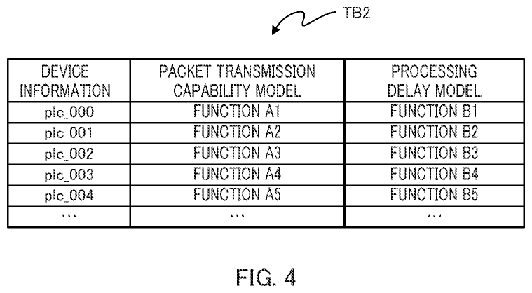

FIG. 4 illustrates an example of actual measurement model table TB2. As for actual measurement model table TB2 illustrated in FIG. 4, the device information and both of a packet transmission capability model and a processing delay model with respect to a CPU load are associated with each other.

The actual measurement model may be represented by using, for example, a function. For example, the packet transmission capability model may be a function that uses the CPU load as a variable and that represents packet transmission capability. For example, the processing delay model may be a function that uses the CPU load as a variable and that represents the processing delay of the CPU.

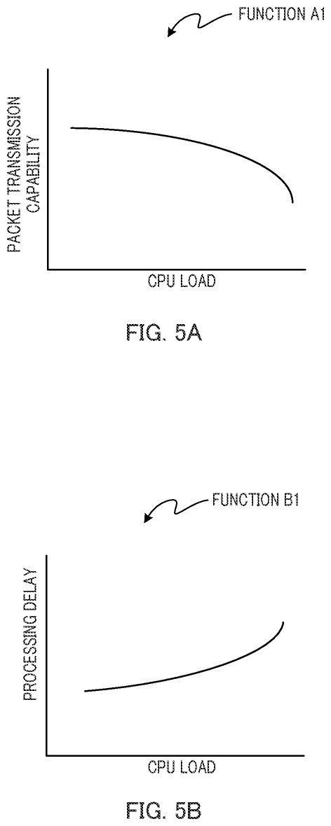

FIG. 5A illustrates an example of the function of the packet transmission capability model in device information “plc_000” in FIG. 4. As illustrated in FIG. 5A, the packet transmission capability model may be represented by a function A1 where the horizontal axis represents the CPU load, and the vertical axis represents the packet transmission capability. In an example in FIG. 5A, as for the device that is represented by the device information “plc_000”, as the CPU load increases, the packet transmission capability (the timing with which the packet is generated) reduces.

FIG. 5B illustrates an example of the function of the processing delay model in the device information “plc_000” in FIG. 4. As illustrated in FIG. 5B, the processing delay model may be represented by a function B1 where the horizontal axis represents the CPU load, and the vertical axis represents the processing delay of the CPU. In an example in FIG. 5B, as for the device that is represented by the device information “plc_000”, as the CPU load increases, the processing delay increases.

FIG. 4 illustrates actual measurement model table TB2 in the case where the devices are PLCs, but the devices are not limited to PLCs. The actual measurement model that is held in actual measurement model table TB2 is not limited to the examples in FIG. 5A and FIG. 5B.

For example, device information about a switch may be stored as the device information in actual measurement model table TB2. Actual measurement model table TB2 may be a table in which the switch and the processing delay model of the switch are associated with each other.

Information processing apparatus 10 uses the actual measurement model and consequently enables the simulation suitable for reality to be run. In some cases, however, the simulation based on the actual measurement model cannot be run. In these cases, parameter generator 14 may generate the parameters again.

For example, in some cases, traffic settings (for example, the timing with which the packet is generated (transmitted)) that are generated by parameter generator 14 in the example for the PLCs described above result in packet transmission capability exceeding the packet transmission capability that is defined in the packet transmission capability model. In this case, it is thought that even in the case where the traffic settings that are generated by parameter generator 14 are set in an actual device, the traffic thereof is not generated. For this reason, parameter generator 14 may generate the parameters of the traffic settings again (different parameters may be generated).

### Simulator

Simulator 16 runs a simulation of the operation of the network, based on the topology information that is outputted from parameter generator 14, the setting information and the device information about the existing device and the new device that are outputted from parameter generator 14, the target performance that is outputted from input processor 13, and actual measurement model table TB2 of actual measurement model memory 15.

For example, simulator 16 creates the topology (network) to be simulated, based on the topology information that is outputted from parameter generator 14. Simulator 16 sets the operations of the existing device and the new device that are included in the created network by using the setting information and the device information about the existing device and the new device that are outputted from parameter generator 14. Simulator 16 runs a simulation of the operation of the network that includes the existing device and the new device the operations of which are set in accordance with the target performance that is outputted from input processor 13. For example, in the case where the item of the target performance that is outputted from input processor 13 is a cycle time, simulator 16 runs a simulation of the cycle time of the network. Simulator 16 uses actual measurement model table TB2 for the simulation of the operations of the devices and consequently improves the precision of the simulation.

Simulator 16 outputs the result of the simulation and simulation information in the result of the simulation to output processor 17. For example, in the case where an object to be simulated (the item of the target performance) is a cycle time, the result of the simulation is the cycle time. The simulation information corresponds to the parameters that are used for the simulation and includes the setting information and the device information about the existing device and the new device, the topology information, and the cost of the new device.

### Output Processor

Output processor 17 stores the result of the simulation and the simulation information in the result of the simulation that are outputted from simulator 16 in the memory.

Output processor 17 stores the result of the simulation and the simulation information in the result of the simulation in the memory and subsequently determines whether the simulation is run again by using changed parameters or whether the simulation ends, and a recommendation is provided to the user. For example, in the case where the number of times the simulation is run is equal to or more than a certain value, in the case where the performance of the network is equal to or more than a certain value, or in the case where the performance equal to or more than the target performance can be achieved at a predetermined cost or less, output processor 17 determines that the simulation ends, and the recommendation is provided to the user.

In the case where it is determined that the simulation ends, output processor 17 outputs the target performance and the budget that are outputted from input processor 13 and the result of the simulation and the simulation information that are stored in the memory to display section 18.

Output processor 17 may sort the result of the simulation and the simulation information that are stored in the memory with the result of the simulation, the simulation information, or both used as conditions and may output these to display section 18. For example. output processor 17 may sort the result of the simulation and the simulation information that are stored in the memory in the order of the cost that is contained in the simulation information and may output these to display section 18. Output processor 17 may restrict the number of the result of the simulation and the simulation information that are stored in the memory and may output these to display section 18.

In the case where it is determined that the simulation is to be run again, output processor 17 outputs the result of the simulation and the simulation information that are outputted from simulator 16 to parameter generator 14 (feedback).

Parameter generator 14 changes the parameters by using information that is fed back from output processor 17. For example, parameter generator 14 may identify a parameter that causes the result of the simulation to greatly change, may change the identified parameter by a certain value, and may use the parameter in a next simulation.

Information processing apparatus 10 repeats the generation of the parameters and the simulation and consequently finds the new network that can achieve the target performance of the user. A method of selecting the new device by using device candidate table TB1, a method of changing the setting information about the selected new device, a method of changing the setting information about the existing device, and a method (a method of generating the parameters) of changing the topology information are not limited to the above description but may be freely selected methods.

### Display Section

Display section 18 causes the display to display the target performance, the budget, the result of the simulation, and the simulation information that are outputted from output processor 17.

FIG. 6 illustrates an example of output screen 30 that is displayed on the display. As illustrated in FIG. 6, output screen 30 includes user setting information image section 31, recommendation device information image section 32. recommendation network image section 33, and recommendation setting information image section 34. The image sections of output screen 30 will now be described.

### User Setting Information Image Section

The budget and the target performance of the network that are set (inputted) by the user via input screen 20 are displayed on user setting information image section 31.

### Recommendation Device Information Image Section

A list of the performance of the network that corresponds to the result of the simulation. the total cost of the new device to be purchased, the device information such as the model number of the new device that is included in the new network, and information about the costs of the devices is displayed on recommendation device information image section 32. A list of the results of multiple simulations may be displayed on recommendation device information image section 32. FIG. 6 illustrates a list of the results of four simulations of No. 1 to No. 4.

### Recommendation Network Image Section

The network (the topology) that is simulated by simulator 16 is displayed on recommendation network image section 33.

In the case where a row of the list that is displayed on recommendation device information image section 32 is clicked, display section 18 may cause the network of the result of the simulation that corresponds to the clicked row to be displayed on recommendation network image section 33. The network in the case where a row of “No. 1” on recommendation device information image section 32 is clicked is displayed on recommendation network image section 33 in FIG. 6. The network on recommendation network image section 33 includes “plc_001” and “plc_002” that correspond to the new device. The new device that is newly added into the network or that is a replacement may be emphasized and displayed.

### Recommendation Setting Information Image Section

The setting information about each device that is included in the network is displayed on recommendation setting information image section 34.

In the case where a device of the network that is displayed on recommendation network image section 33 is clicked, display section 18 may display the setting information about the clicked device as recommendation setting information image section 34 that pops up. FIG. 6 illustrates an example in the case where “PLC_A” of the network that is displayed on recommendation network image section 33 is clicked. Naturally, recommendation setting information image section 34 may be displayed by using a display method other than a popping-up display method and may be displayed on, for example, another screen that differs from output screen 30.

For example, the user refers the network that is displayed on recommendation network image section 33 and can easily establish a network that has improved performance. In addition, for example, the user refers the setting information about the device that is displayed on recommendation setting information image section 34 and can easily set the operation of the device that is included in the network. In addition, for example, the user selects a row of the list of the result of the simulation that is displayed on recommendation device information image section 32 and can consequently refer another network that has improved performance.

The setting information about the device that is included in the network may be outputted into a file. The changed setting information may be emphasized and displayed.

Display section 18 may display the network before the simulation and the network after the simulation together. This enables the user to easily compare the network before the simulation and the network after the simulation. Display section 18 may display a location (a device) that becomes a bottleneck for achieving the target performance.

Output screen 30 corresponds to an example of a recommendation based on the result of the simulation that represents that replacement with the new device enables a processing speed to be improved, a change in the topology enables the processing delay to be reduced, and reevaluation of the timing with which the traffic is generated enables the delay of transmission of the traffic between devices to be reduced and consequently enables the cycle time to be improved.

The image sections of output screen 30 will now be described.

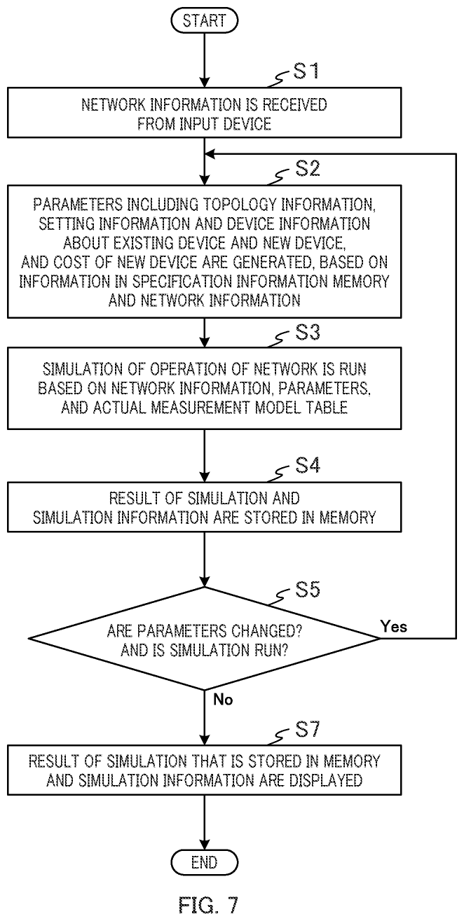

An example of the operation of information processing apparatus 10 will now be described by using a flowchart. FIG. 7 is a flowchart illustrating the example of the operation of information processing apparatus 10.

Information processing apparatus 10 receives the network information from the input device (S1). For example, information processing apparatus 10 causes the display to display input screen 20 illustrated in FIG. 2 and receives the network information from the input device.

Examples of the network information include the target performance of the new network, the budget that can be used for establishing the new network, and the topology restriction in the new network. The examples of the network information also include the device information about the existing device that is included in the existing network, the setting information about the existing device, and the topology information about the existing network.

Information processing apparatus 10 may obtain the device information about the existing device, the setting information about the existing device, and the topology information about the existing network from a file or the device that is included in the existing network.

Information processing apparatus 10 generates the parameters including the topology information about the new network, the setting information and the device information about the existing device and the new device that are included in the new network, and the cost of the new device, based on information that is stored in specification information memory 14a and the network information that is received at S1 (S2).

For example, information processing apparatus 10 refers specification information memory 14a, obtains the cost and the device information about the new device that satisfies the budget that is contained in the network information that is received at S1, and generates device candidate table TB1 (see, for example, FIG. 3).

Information processing apparatus 10 refers device candidate table TB1 that is generated and changes the topology information (the existing network) that is included in the network information that is received at S1. For example, information processing apparatus 10 replaces the existing device that is included in the existing network with the new device that is included in device candidate table TB1 or adds the new device that is included in device candidate table TB1 into the existing network and changes the existing network.

Information processing apparatus 10 obtains the setting information and the device information about the existing device and the new device that are included in the network (the new network) into which the existing network is changed. Information processing apparatus 10 obtains the cost of the new device that is included in the new network. The setting information and the device information about the existing device are included in the network information that is received at S1. The cost and the setting information about the new device are obtained by referring specification information memory 14a.

Through the processing described above, information processing apparatus 10 generates the parameters including the topology information about the new network, the setting information and the device information about the existing device and the new device that are included in the new network, and the cost of the new device.

In the case where the processing proceeds from S5 to S2, information processing apparatus 10 generates different parameters that differ from the parameters generated before (for example, previously). For example, information processing apparatus 10 changes the setting information about the existing device and the new device, the topology information, or both. An example of a changing method may be the same as the method described in [Output Processor] described above.

Information processing apparatus 10 runs a simulation of the operation of the network, based on a performance target that is contained in the network information that is received at S1, the parameters that are generated at S2, and actual measurement model table TB2 (see, for example, FIG. 4) (S3).

For example, information processing apparatus 10 creates the topology (the network) to be simulated, based on the topology information about the parameters that are generated at S2. Information processing apparatus 10 sets the operations of the existing device and the new device that are included in the created network by using the setting information and the device information about the existing device and the new device that are generated at S2. Information processing apparatus 10 runs a simulation of the operation of the network that includes the existing device and the new device the operations of which are set in accordance with the target performance that is contained in the network information that is received at S1. For example, in the case where the item of the target performance that is contained in the network information that is received at S1 is a cycle time, information processing apparatus 10 runs a simulation of the cycle time of the network. As for the simulation of the operations of the devices, information processing apparatus 10 improves the precision of the simulation by using actual measurement model table TB2.

Information processing apparatus 10 stores the result of the simulation at S3 and the simulation information about the result of the simulation in the memory (S4).

The simulation information corresponds to the parameters that are used for the simulation at S3 and includes the topology information about the simulated new network, the setting information and the device information about the existing device and the new device that are included in the new network, and the cost of the new device.

Information processing apparatus 10 determines whether the parameters are changed, and the simulation is run (S5).

For example, in the case where the number of times the simulation is run is equal to or more than a certain value, in the case where the performance of the network is equal to or more than a certain value, or in the case where the performance equal to or more than the target performance can be achieved at a predetermined cost or less, information processing apparatus 10 determines that the parameters are changed, but the simulation is not run (it is determined that the simulation ends).

In the case where it is determined that the simulation is run at S5, (Yes in S5), information processing apparatus 10 performs a process at S2. In the case where the processing proceeds from S5 to S2, information processing apparatus 10 generates the parameters that differ from the parameters generated before as described above.

In the case where it is determined that the simulation is not run at S5 (No at S5), information processing apparatus 10 causes the display to display the result of the simulation that is stored in the memory at S4 and the simulation information in the result of the simulation (S7). For example, information processing apparatus 10 causes the display to display output screen 30 illustrated in FIG. 6.

Simulator 16 sets the operation of each device that is included in the network and runs a simulation of the operation of the network as described above. Display section 18 causes the display to display the result of the simulation of simulator 16 and the setting information that represents the setting content of each device that is included in the simulated network.

Information processing apparatus 10 causes the display to display the setting information about each device that is included in the network the operation of which is simulated. Consequently, in the case where the new network based on the simulation of the operation is established, the user can easily set the operation of each device that is included in the new network, based on the setting information about each device that is displayed on the display of information processing apparatus 10 and can easily establish the new network.

For example, as illustrated in recommendation setting information image section 34 of output screen 30 in FIG. 6, the setting information about each device that is included in the simulated network is displayed on the display. Accordingly, the user can easily set the operation of each device that is included in the network to be established, based on the setting information about each device that is displayed on the display of information processing apparatus 10 and can easily establish the network based on the simulation of the operation.

In an example described above, the operation of the industrial network is simulated, but an object to be simulated is not limited to the industrial network. A technique according to the present disclosure can be used for a communication network such as a LAN (Local Area Network) or a mobile phone network.

In the above-described embodiments, the expressions “processor,” “-er,” “-or,” and “-ar” used for the component elements may be replaced with other expressions such as “circuit (circuitry),” “assembly,” “device,” “unit,” or “module.”

Although the embodiments have been described above with reference to the drawings, the present disclosure is not limited to such examples. It is clear that a person skilled in the art is capable of conceiving various changes and modifications within the scope of the claims. It is understood that such changes or modifications also fall within the technical scope of the present disclosure. Further, the component elements in the embodiments may be arbitrarily combined without departing from the spirit of the present disclosure. In addition, variations in the embodiments may be combined arbitrarily.

The present disclosure can be realized by software, hardware, or software in cooperation with hardware. Each functional block used in the description of each embodiment described above can be partly or entirely realized by an LSI such as an integrated circuit, and each process described in the each embodiment may be controlled partly or entirely by the same LSI or a combination of LSIs. The LSI may be individually formed as chips, or one chip may be formed so as to include a part or all of the functional blocks. The LSI may include a data input and output coupled thereto. The LSI here may be referred to as an IC, a system LSI, a super LSI, or an ultra LSI depending on a difference in the degree of integration.

However, the technique of implementing an integrated circuit is not limited to the LSI and may be realized by using a dedicated circuit, a general-purpose processor, or a special-purpose processor. In addition, a FPGA (Field Programmable Gate Array) that can be programmed after the manufacture of the LSI or a reconfigurable processor in which the connections and the settings of circuit cells disposed inside the LSI can be reconfigured may be used. The present disclosure can be realized as digital processing or analogue processing.

If future integrated circuit technology replaces LSIs as a result of the advancement of semiconductor technology or other derivative technology, the functional blocks could be integrated using the future integrated circuit technology. Biotechnology can also be applied.

This application is entitled and claims the benefit of Japanese Patent Application No. 2021-208509, filed on Dec. 22, 2021, the disclosure of which including the specification, drawings and abstract is incorporated herein by reference in its entirety.

### INDUSTRIAL APPLICABILITY

The present disclosure is useful for a simulation of an industrial network.

### REFERENCE SIGNS LIST

10 information processing apparatus
11 user input section
12 network information obtaining section
13 input processor
14 parameter generator
14a specification information memory
14b new device candidate selector
14c topology generator
14d topology restriction validator
14e device setting generator
15 actual measurement model memory
16 simulator
17 output processor
18 display section

1. An information processing apparatus, comprising:
a simulation circuit that sets an operation of a device included in a network and that runs a simulation of an operation of the network; and
a display circuit that causes a display device to display a result of the simulation and setting information that represents a setting content of the device.

2. The information processing apparatus according to claim 1, further comprising:
a change circuit that adds a new device into the network or that replaces the device with the new device,
wherein the simulation circuit sets an operation of the new device and runs a simulation of an operation of the network that includes the new device.

3. The information processing apparatus according to claim 2,
wherein the simulation circuit changes a setting for the operations of the device and the new device and repeatedly runs the simulation of the operation of the network.

4. The information processing apparatus according to claim 2,
wherein the change circuit changes a topology of the network such that the topology satisfies a topology restriction that is set by a user.

5. The information processing apparatus according to claim 2,
wherein the simulation circuit refers an actual measurement model of the new device and the device and runs the simulation of the operation of the network.

6. The information processing apparatus according to claim 2,
wherein the simulation circuit sets, in the device and the new device, at least one of a timing with which traffic is generated, a traffic size, a traffic priority, a queue priority, and/or an algorithm for queue priority control.

7. The information processing apparatus according to claim 1,
wherein the display circuit causes the display device to display a topology of the network that is simulated.

8. A simulation method, comprising:
setting an operation of a device included in a network and running a simulation of an operation of the network; and
causing a display device to display a result of the simulation and setting information that represents a setting content of the device.
